(19) United States
(12) Patent Application Publication
(10) Pub. No.: US 2022/0270215 A1
(43) Pub. Date: Aug. 25, 2022

(54) METHOD FOR APPLYING BOKEH EFFECT TO VIDEO IMAGE AND RECORDING MEDIUM

(71) Applicant: NALBI INC., Seoul (KR)

(72) Inventor: Young Su LEE, Seoul (KR)

(73) Assignee: NALBI INC., Seoul (KR)

(21) Appl. No.: 17/668,545

(22) Filed: Feb. 10, 2022

Related U.S. Application Data
(63) Continuation of application No. PCT/KR2020/012058, filed on Sep. 7, 2020.

(30) Foreign Application Priority Data
Sep. 6, 2019 (KR) 10-2019-0111055
Sep. 4, 2020 (KR) 10-2020-0113328

(51) Int. Cl. G06T 5/00; G06T 7/70; G06T 7/60; G06T 7/536; G06T 5/50; G06T 3/40; G06T 7/11

(52) U.S. Cl. CPC G06T 5/002; G06T 7/70; G06T 7/60; G06T 7/536; G06T 5/50; G06T 3/40; G06T 7/11; G06T 2207/10016; G06T 2207/30201; G06T 2207/20212; G06T 2207/20084

(57) ABSTRACT

A method for applying a bokeh effect to a video image in a user terminal is provided. The method for applying a bokeh effect includes extracting characteristic information of an image from the image included in the video image, analyzing the extracted characteristic information of the image, selecting a bokeh effect to be applied to the image based on the analyzed characteristic information of the image, and applying the determined bokeh effect to the image.

### CROSS-REFERENCE TO RELATED APPLICATIONS

This application is a continuation of International Application No. PCT/KR2020/012058 filed on Sep. 7, 2020, which claims priority to Korean Patent Application No. 10-2019-0111055filed on Sep. 6, 2019 and Korean Patent Application No. 10-2020-0113328filed on Sep. 4, 2020, the entire contents of which are herein incorporated by reference.

### TECHNICAL FIELD

The present disclosure relates to a method for applying a bokeh effect to a video image and a recording medium, and more particularly, to a method for applying, on a real-time video image, focusing, out-focusing, and bokeh effects, which are realizable only on an image captured with a single lens reflex camera (SLR) or digital single-lens reflex camera (DSLR) with a large aperture diameter, by using computer vision technology, and a recording medium.

### BACKGROUND

When a person appears in a real-time video input, it is common to assume that the image is being captured with a focus on the center of the person, and by further analyzing information on the person, the bokeh effect can be generated automatically and naturally.

Since the algorithm operation speed must be fast enough to apply the bokeh effect in real time, image processing at a lower resolution than the original is recommended, but it is also aesthetically important to have the same level of sharpness as the original in the in-focus part or the part determined to need sharpness.

### SUMMARY

### Technical Problem

In order to solve the problems described above, the present disclosure provides a method for applying a bokeh effect to a video image and a recording medium.

In an environment such as a mobile camera or the like where real-time video input is received, when no actual depth information is given, bokeh effect can be implemented in various ways to generate a natural image.

Some methods have already been commercialized, such as a method of simply generating focusing and defocusing effects like DSLR by applying a segmentation mask to make the object region clear and the background region blurred, but most of these methods give a consistent blur effect to the background region, thus suffering a disadvantage that it is not natural and is not able to express a strong blur effect.

### Technical Solution

A method for applying a bokeh effect to a video image according to an embodiment of the present disclosure includes extracting characteristic information of an image from the image included in the video image, analyzing the extracted characteristic information of the image, selecting a bokeh effect to be applied to the image based on the analyzed characteristic information of the image, and applying the determined bokeh effect to the image.

According to an embodiment, the analyzing the extracted characteristic information of the image includes detecting an object in the image, generating a region corresponding to the object in the image, determining at least one of a position, a size, and a direction of the region corresponding to the object in the image, and analyzing characteristics of the image based on information on at least one of a position, a size, and a direction of the region corresponding to the object.

According to an embodiment, the object in the image may include at least one of a person object, a face object, and a landmark object included in the image, and the determining at least one of the position, size, and direction of the object in the image includes determining a ratio between a size of the image and a size of the region corresponding to the object, and the analyzing the characteristics of the image based on the information on at least one of the position, size, and direction of the object includes classifying a pose of the object included in the image.

According to an embodiment, the analyzing the extracted characteristic information of the image includes detecting at least one of an asymptote (horizon) and a height of a vanishing point included in the image, and analyzing a depth characteristic in the image based on at least one of the detected the asymptote and height of vanishing point.

According to an embodiment, the determining the bokeh effect to be applied to the image includes, based on the analyzed characteristic information of the image determining a type of a bokeh effect to c of applying the same.

According to an embodiment, the method for applying a bokeh effect to a video image further includes receiving input information on an intensity of the bokeh effect for the video image, and the applying the bokeh effect to the image includes determining an intensity of the bokeh effect based on the received input information on the intensity, and applying the bokeh effect to the image according to the determination.

According to an embodiment, the applying the determined bokeh effect to the image includes generating sub-images corresponding to regions to which a blur effect is to be applied in the image, applying the blur effect to sub-images, and mixing the sub-images applied with the blur effect.

According to an embodiment, the applying the determined bokeh effect to the image further includes down-sampling the image to generate a low resolution image with a lower resolution than that of the image, and the generating the sub-images corresponding to the regions to be applied with the blur effect in the image includes applying a blur effect to the regions corresponding to the sub-images in the low resolution image.

According to an embodiment, the mixing the sub-images applied with the blur effect includes mixing the low resolution image and the sub-images corresponding to the regions applied with the blur effect, up-sampling the low resolution image mixed with the sub-images to a resolution same as the resolution of the image, mixing the image and the up-sampled images to correct a sharpness of the up-sampled image.

According to an embodiment, the method includes the steps of (a) receiving information on a plurality of image frames, (b) inputting the information on the plurality of image frames into a first artificial neural network model to generate a segmentation mask for one or more objects included in the plurality of image frames, (c) inputting the information on the plurality of image frames into a second artificial neural network model to extract a depth map for the plurality of image frames, and (d) applying a depth effect to the plurality of image frames based on the generated segmentation mask and extracted depth map.

According to an embodiment, the step (d) includes correcting the extracted depth map using the generated segmentation mask, and applying a depth effect to the plurality of image frames based on the corrected depth map.

According to an embodiment, each of the steps (a) to (d) is executed by any one of a plurality of heterogeneous processors.

A computer-readable medium is provided, storing a computer program for executing, on a computer, the method for applying a bokeh effect to a video image according to an embodiment of the present disclosure.

### Advantageous Effects

According to some embodiments of the present disclosure, by using a segmentation mask, it is possible to provide a method for applying a bokeh effect to a video image and a recording medium, in which a degree, a range, and a method of the effect are automatically adjusted according to the characteristics of the input image and adjustment to the intensity by the user.

According to some embodiments of the present disclosure, since the bokeh effect is applied in the image using the depth map of the image and information on the object to be focused in the image, the depth effect can be applied differentially to the background regions of the image, and the depth effect can also be applied differentially to the object regions within the image.

The effects of the present disclosure are not limited to the effects described above, and other effects that are not mentioned above can be clearly understood to those skilled in the art based on the description provided below.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings.

FIG. 1 is an exemplary diagram illustrating a method for applying a bokeh effect to a video image according to an embodiment of the present disclosure.

FIG. 2 is a flowchart of a method for applying a bokeh effect to a video image according to an embodiment of the present disclosure.

FIG. 3 is a block diagram of a system for applying a bokeh effect to a video image according to an embodiment of the present disclosure.

FIG. 4 is a flowchart of an image processing method of a processing unit of a system for applying a bokeh effect to a video image according to an embodiment of the present disclosure.

FIG. 5 is an exemplary diagram for explaining a process of analyzing extracted characteristic information of an image according to an embodiment of the present disclosure.

FIG. 6 is an exemplary diagram for explaining a process of classifying a pose of an object in a process of analyzing extracted characteristic information of an image according to an embodiment of the present disclosure.

FIG. 7 is an exemplary diagram for explaining a process of analyzing a depth characteristic in an image by detecting at least one of an asymptote (horizon) and a height of a vanishing point included in the image in the process of analyzing the extracted characteristic information of the image according to an embodiment of the present disclosure.

FIG. 8 is an exemplary diagram for explaining a process of determining, based on the analyzed characteristic information of the image, a type of bokeh to be applied to an image and a method of applying the same, according to an embodiment of the present disclosure.

FIG. 9 is an exemplary diagram for explaining a process of determining, based on the analyzed characteristic information of the image, a type of bokeh to be applied to an image and a method of applying the same, according to an embodiment of the present disclosure.

FIG. 10 is an exemplary diagram for explaining a process of receiving input information on the intensity of a bokeh effect for a bokeh video image according to an embodiment of the present disclosure.

FIG. 11 is a flowchart for explaining a step of applying a bokeh effect to an image according to an embodiment of the present disclosure.

FIG. 12 is an exemplary diagram for explaining a process of correcting a depth map by using a segmentation mask according to an embodiment of the present disclosure.

FIG. 13 is a schematic diagram illustrating a data flow of a video bokeh solution according to an embodiment of the present disclosure.

FIG. 14 is a schematic diagram illustrating a data flow of a video bokeh solution according to an embodiment of the present disclosure.

FIG. 15 is a schematic diagram illustrating a data flow of a video bokeh solution according to an embodiment of the present disclosure.

FIG. 16 is a block diagram of a data flow of a video bokeh solution according to an embodiment of the present disclosure.

FIG. 17 illustrates an example of an artificial neural network model according to an embodiment of the present disclosure.

### DETAILED DESCRIPTION

Hereinafter, specific details for the practice of the present disclosure will be described in detail with reference to the accompanying drawings. However, in the following description, detailed descriptions of well-known functions or configurations will be omitted when it may make the subject matter of the present disclosure rather unclear.

In the accompanying drawings, the same or corresponding elements are assigned the same reference numerals. In addition, in the following description of the embodiments, duplicate descriptions of the same or corresponding elements may be omitted. However, even if descriptions of components are omitted, it is not intended that such components are not included in any embodiment.

Advantages and features of the disclosed embodiments and methods of accomplishing the same will be apparent by referring to embodiments described below in connection with the accompanying drawings. However, the present disclosure is not limited to the embodiments disclosed below, and may be implemented in various different forms, and the embodiments are merely provided to make the present disclosure complete, and to fully disclose the scope of the invention to those skilled in the art to which the present disclosure pertains.

The terms used in the present disclosure will be briefly described prior to describing the disclosed embodiments in detail.

The terms used herein have been selected as general terms which are widely used at present in consideration of the functions of the present disclosure, and this may be altered according to the intent of an operator skilled in the art, conventional practice, or introduction of new technology. In addition, in specific cases, certain terms may be arbitrarily selected by the applicant, and the meaning of the terms will be described in detail in a corresponding description of the embodiments. Therefore, the terms used in the present disclosure should be defined based on the meaning of the terms and the overall content of the present disclosure rather than a simple name of each of the terms.

As used herein, the singular forms “a,” “an,” and “the” are intended to include the plural forms as well, unless the context clearly indicates the singular forms. Further, the plural forms are intended to include the singular forms as well, unless the context clearly indicates the plural forms.

Further, throughout the description, when a portion is stated as “comprising (including)” an element, it intends to mean that the portion may additionally comprise (or include or have) another element, rather than excluding the same, unless specified to the contrary.

In the present disclosure, the term “module” denotes a software or hardware component, and the “module” performs certain roles. However, the meaning of the “module” is not limited to software or hardware. The “module” may be configured to be in an addressable storage medium or configured to execute one or more processors. Accordingly, as an example, the “module” includes elements such as software elements, object-oriented software elements, class elements, and task elements, processes, functions, attributes, procedures, subroutines, program code segments, drivers, firmware, micro-codes, circuits, data, database, data structures, tables, arrays, and variables. Furthermore, functions provided in the components and the “modules” may be combined into a smaller number of components and “modules”, or further divided into additional components and “modules”.

The term “module” denotes a software or hardware component, and performs certain roles.

In the present disclosure, a “system” may refer to at least one of a server device and a cloud server device, but is not limited thereto.

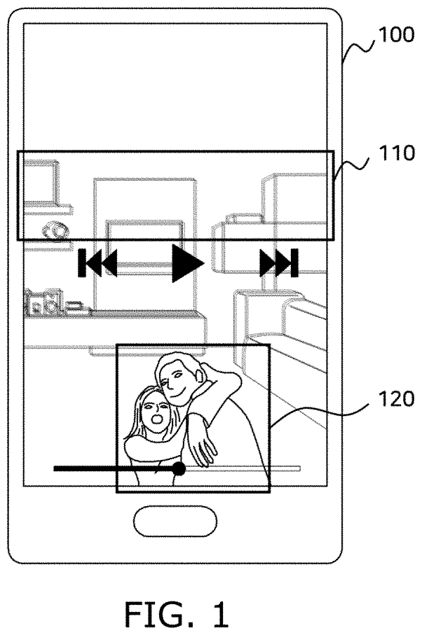

In the present disclosure, a “user terminal” may include any electronic device (e.g., smartphone, PC, tablet PC, laptop PC, and the like) that is provided with a communication module to enable network connection, and can output content by accessing website, application, or the like. The user may be provided with any content accessible through the network by input through an interface of the user terminal (e.g., touch display, keyboard, mouse, touch pen or stylus, microphone, motion recognition sensor, and the like) through the user terminal. FIG. 1 is an exemplary diagram illustrating a method for applying a bokeh effect to a video image according to an embodiment of the present disclosure.

In FIG. 1, a user terminal 100 is illustrated as a smart phone, but embodiments are not limited thereto, and it may be any electronic device (e.g., PC, tablet PC, laptop PC, and the like) that is provided with a camera and thus capable of capturing an image, that is also provided with a device capable of controlling a computer system, such as a Central Processing Unit (CPU) or Graphics Processing Unit (GPU) or Neural Processing Unit (NPU), or the like, and executing the operation of a program, and that is capable of outputting video image content. The user may control the intensity of the bokeh effect to be applied to the video image by inputting through the interface of the user terminal 100 (e.g., touch display, keyboard, mouse, touch pen or stylus, microphone, motion recognition sensor). As another example, the user terminal 100 may be provided with a service for applying a bokeh effect to a video image through an application provided by any server.

As illustrated in FIG. 1, the bokeh effect may be applied to a video image in the user terminal 100. In an embodiment, while simultaneously continuing with the video recording, it is possible to see on a screen the processing of bokeh effect in real time, in which the blur effect is applied to a background region 110, and not applied to the foreground region, which is a person object region 120.

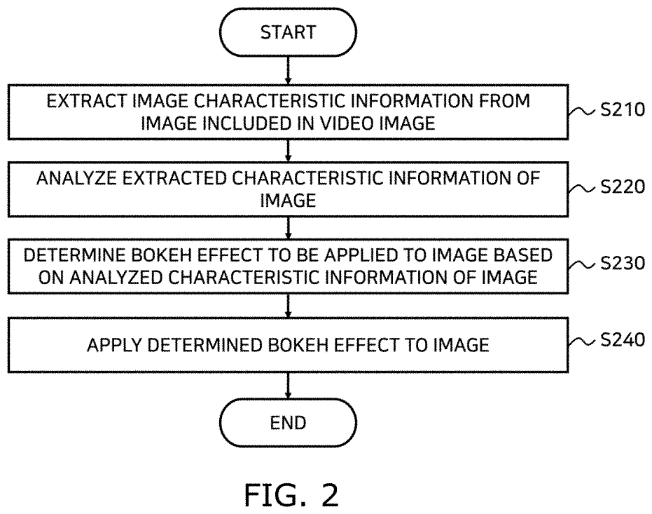

FIG. 2 is a flowchart of a method for applying a bokeh effect to a video image according to an embodiment of the present disclosure. A method for applying a bokeh effect to a video image in a user terminal may include extracting characteristic information of an image from the image included in the video image, analyzing the extracted characteristic information of the image, selecting a bokeh effect to be applied to the image based on the analyzed characteristic information of the image, and applying the determined bokeh effect to the image.

At S210, the system for applying a bokeh effect may extract the characteristic information of the image from the image included in the video image. By the “characteristic information”, it may mean information that can be extracted from the image, such as RGB values and the like of pixels in the image, but is not limited thereto.

At S220, the system for applying a bokeh effect may analyze the extracted characteristic information of the image. For example, it is possible to receive the characteristic information extracted from the input image and analyze the characteristic information for determining the type and intensity of a bokeh effect to be applied to the input image.

At S230, the system for applying a bokeh effect may determine a bokeh effect to be applied to the image based on the analyzed characteristic information of the image. The determined bokeh effect may include flat bokeh, gradient bokeh, or the like, but is not limited thereto.

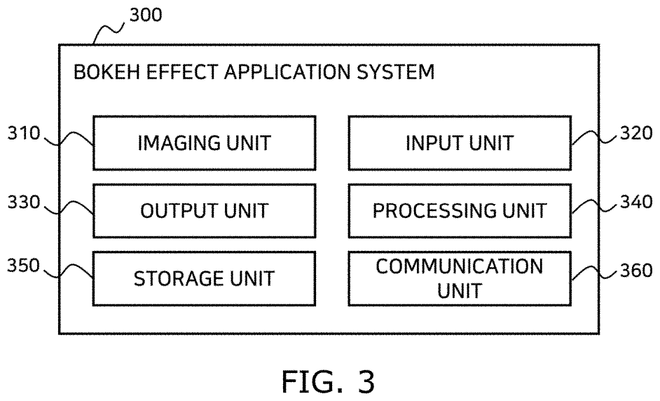

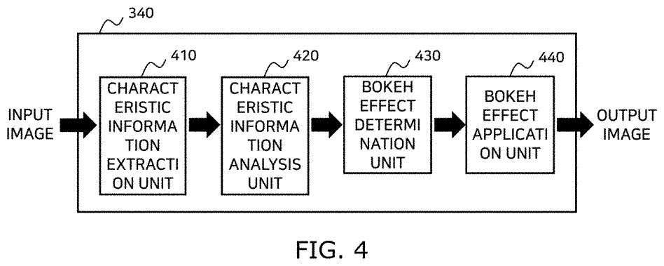

At S240, the system for applying a bokeh effect may apply the determined bokeh effect to the image, and the detailed configuration will be described with reference to FIGS. 3 and 4 below.

FIG. 3 is a block diagram of a system for applying a bokeh effect to a video image according to an embodiment of the present disclosure. As illustrated in FIG. 3, a system 300 for applying a bokeh effect may include an imaging unit 310, an input unit 320, an output unit 330, a processing unit 340, a storage unit 350, and a communication unit 360.

In an embodiment, the imaging unit 310 may capture an input image for applying the bokeh effect and transmit it to the storage unit 350. The imaging unit 310 may include a camera or the like to capture a picture or an image. The camera may be configured as a monocular camera having one lens and one sensor, or a camera having two or more lenses and sensors, but is not limited thereto.

In an embodiment, the input unit 320 may receive an intensity of input from the user to determine the type, intensity, and distribution of intensities of bokeh effect to be applied when a bokeh effect application unit 440 applies the bokeh effect to the input image.

In an embodiment, the output unit 330 may receive the input image applied with the bokeh effect from the storage unit 350.

In another embodiment, the output unit 330 may output the input image applied with the bokeh effect to check it in real time.

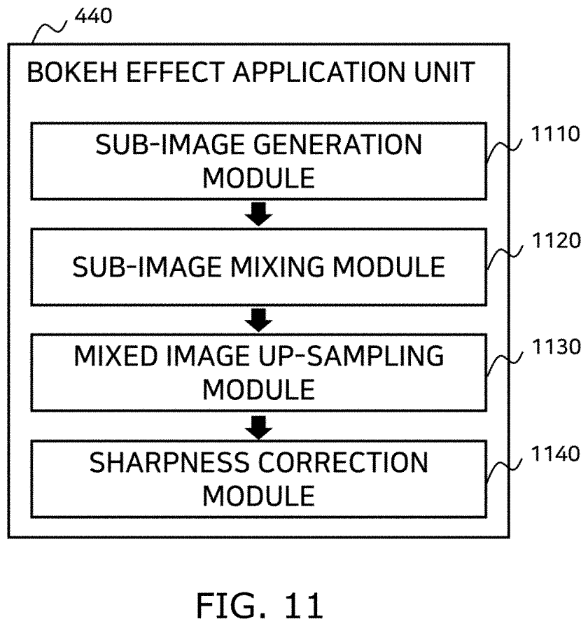

In an embodiment, the processing unit 340 may extract characteristic information from the input image, analyze the characteristic information based on the extracted characteristic information, and determine a bokeh effect based on the analyzed characteristic information. In addition, based on the bokeh effect determined and the input information on the intensity of bokeh effect received from the user, the processing unit 340 may determine the intensity of the blur effect to apply, or the distribution of the intensity of the blur effect. The detailed configuration of the processing unit 340 will be described below with reference to FIGS. 4 and 11.

In an embodiment, the storage unit 350 may store the image captured by the imaging unit 310, or store images (e.g., sub-images, mixed images, down-sampled images, and the like) generated by the processing unit 340 in a series of processes of applying the bokeh effect to the input image, and a final output image. In addition, it may store an external input image received from the communication unit 360 and the like. The storage unit 350 may output the images stored in the storage unit 350 through the output unit 330 or transmit the images used by the processing unit 340 to apply the bokeh effect to the input image through the communication unit 360.

In an embodiment, the communication unit 360 may exchange data within the system 300 for applying a bokeh effect, or communicate with an external server to transmit and receive data such as an image or the like. In another embodiment, the communication unit 360 may receive a service for applying a bokeh effect to a video image through an application provided by any server.

FIG. 4 is a flowchart of an image processing method of a processing unit of a system for applying a bokeh effect to a video image according to an embodiment of the present disclosure. The processing unit 340 may receive, as an input image, a currently-captured image received from the imaging unit 310, or a stored image stored in the user terminal 100 and received from the storage unit 350, and apply the bokeh effect to the image and output the result. As illustrated in FIG. 4, the processing unit 340 may include a characteristic information extraction unit 410, a characteristic information analysis unit 420, a bokeh effect determination unit 430, and the bokeh effect application unit 440. The processing unit 340 may be implemented with the known artificial intelligence techniques, such as machine learning, Convolutional Neural Network (CNN), Recurrent Neural Network (RNN), Deep Neural Network (DNN), and the like including artificial intelligence of a rule-based algorithm.

In an embodiment, the characteristic information extraction unit 410 may refer to information that may be extracted from the image, such as RGB values or the like of pixels in the image, which is necessary for the characteristic information analysis unit 420 to analyze the characteristic information on the input image, but is not limited thereto.

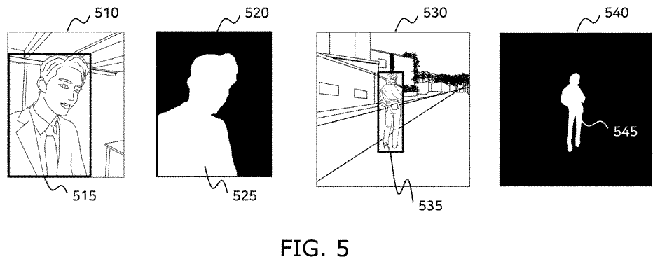

In an embodiment, the characteristic information analysis unit 420 may receive the characteristic information extracted by the characteristic information extraction unit 410 and analyze the characteristic information for determining the type and intensity of the bokeh effect to be applied to the input image. The analyzed image characteristic information generated at the characteristic information analysis unit 420 by analyzing the characteristic information may refer to computer vision information such as an object in an image, a region (bounding box) corresponding to the object in the image, a segmentation mask corresponding to an edge of the object in the image, a facial region (head bounding box) of the object in the image, facial features or landmarks such as eyes, nose, mouth, and the like of a human face in the facial region, proportions and poses of the object in the image, a ground region of the object in the image, asymptotes (horizontal or horizontal lines) and a vanishing point of the background included within the image, and position, size, orientation, and the like of each analyzed element, but is not limited thereto. In addition, a detailed configuration of the characteristic information analysis unit 420 will be described below with reference to FIGS. 5 to 7.

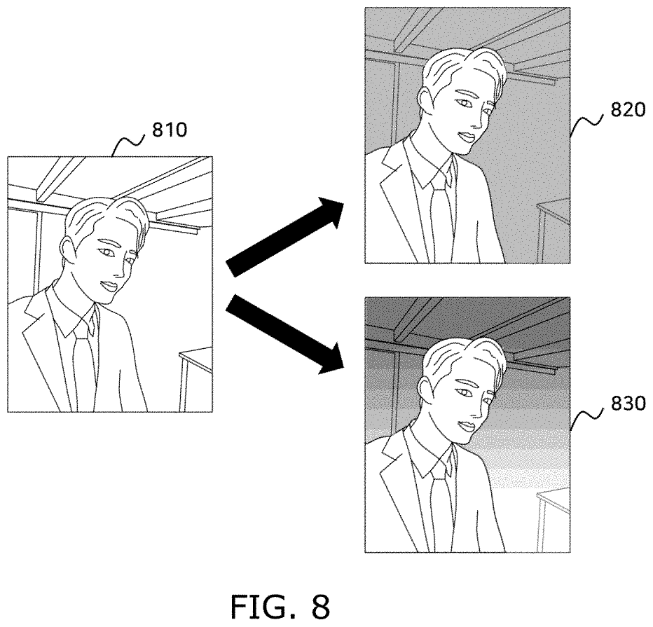

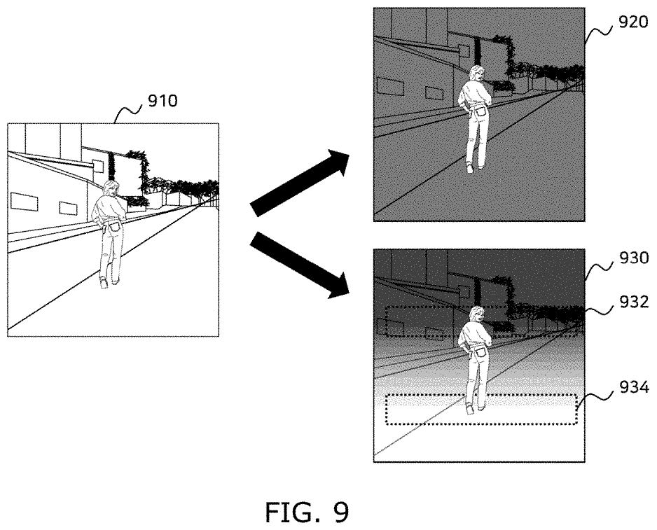

In an embodiment, the bokeh effect determination unit 430 may determine a bokeh effect to be applied to the input image, based on the characteristic information of the image analyzed at the characteristic information analysis unit 420. The bokeh effect determined by the bokeh effect determination unit 430 may include flat bokeh, gradient bokeh, or the like, but is not limited thereto. In addition, the characteristic information analysis unit 420 may be configured with the well-known artificial intelligence technologies, such as a rule- based artificial intelligence, a simple artificial neural network that performs a classification task, or the like, but is not limited thereto. In addition, a detailed configuration of the bokeh effect determination unit 430 will be described below with reference to FIGS. 8 and 9.

In an embodiment, the bokeh effect application unit 440 may determine a distribution of intensities of flat bokeh or intensities of blur effect of gradient bokeh, based on the input information on intensity of bokeh effect received from the user. In addition, in the processing unit 340, as illustrated in FIG. 11 to be described below, a sub-image generation module 1110 of the bokeh effect application unit 440 may store, in the storage unit 350, a sub-image obtained by down-sampling the input image with a lower resolution than that of the input image, and sub-images obtained by applying the blur effect to the generated sub-image.

In an embodiment, when applying the gradient bokeh to the input image, a sub- image mixing module 1120 of the bokeh effect application unit 440 may mix the sub-images applied with the blur effect generated by the sub-image generation module 1110, and store the mixed image in the storage unit 350.

In an embodiment, a mixed image up-sampling module 1130 of the bokeh effect application unit 440 may up-sample a low resolution image that is mixed by the sub-image mixing module 1120.

In an embodiment, a sharpness correction module 1140 of the bokeh effect application unit 440 may correct the sharpness of the image applied with bokeh effect by using the original input image before being applied with the blur effect.

FIG. 5 is an exemplary diagram for explaining a process of analyzing extracted characteristic information of an image according to an embodiment of the present disclosure. As illustrated in FIG. 5, the characteristic information analysis unit 420 may receive the characteristic information extracted by the characteristic information extraction unit 410 and analyze the characteristic information for determining the type and intensity of the bokeh effect to be applied to the input image.

In an embodiment, the characteristic information analysis unit 420 may detect the objects in images 510 and 530 based on the characteristic information extracted by the characteristic information extraction unit, and generate regions (bounding boxes) 515 and 535 corresponding to the objects in the images, and segmentation masks 525 and 545 in images 520 and 540 corresponding to the objects in the images. It can be generated by the object detection with various types of well-known artificial intelligence technologies such as Convolutional Neural Network (CNN), Deep Neural Network (DNN), and the like.

In an embodiment, the characteristic information analysis unit 420 may determine at least one of a position, a size, and a direction of the region corresponding to the object in the image. In addition, the characteristic information analysis unit 420 may analyze characteristics of the image based on the information on at least one of the position, the size, and the direction of the region corresponding to the object, and transmit the analyzed characteristic information to the bokeh effect determination unit 430.

For example, when the size of the region 515 corresponding to the obj ect in the image is 50% of the entire image or larger, and when the region 515 corresponding to the object in the image is aligned with the edge of an image 510, the characteristic information analysis unit 420 may determine the image characteristic to be a selfie.

For example, when the size of the region 535 corresponding to the object in the image is smaller than 50% of the entire image, or when the region 535 corresponding to the object in the image is not aligned with the edge of the image 530, the characteristic information analysis unit 420 may determine the image characteristic to be a full body shot.

In an embodiment, whether the image characteristic is the selfie or the full body shot may be used to determine the type of bokeh effect to be applied to the image by the bokeh effect determination unit 430.

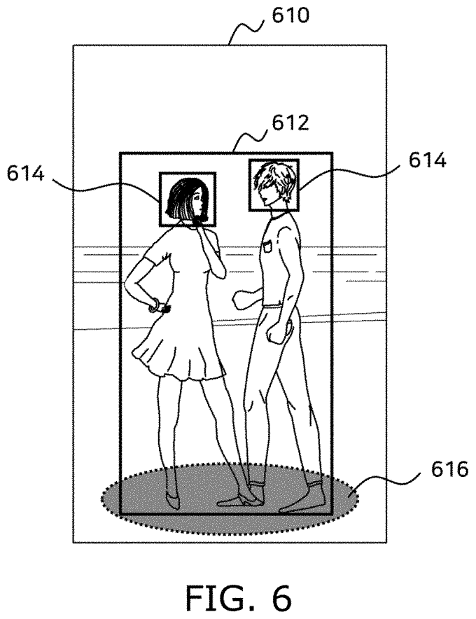

FIG. 6 is an exemplary diagram for explaining a process of classifying a pose of an object in a process of analyzing extracted characteristic information of an image according to an embodiment of the present disclosure. As illustrated in FIG. 6, the object in the image may include at least one of a person object, a face object, and a landmark object included in the image. In addition, determining at least one of the position, size, and direction of the object in the image may include determining a ratio between the size of the image and the size of the region corresponding to the object. In addition, analyzing the characteristics of the image based on the information on at least one of the position, size, and direction of the object may include classifying a pose of the object included in the image.

In an embodiment, the object in an image 610 may include at least one of a person object 612, a face object 614, and a landmark object included in the image. The landmark object may refer to the facial feature points such as eyes, nose, mouth, and the like of a human face in the face object 614 in the image.

In an embodiment, the characteristic information analysis unit 420 may classify the ratios and poses of the objects included in the image, based on the information on at least one of the position, size, direction, and ratio of the object 612 and the face object 614 in the image. For example, it may determine whether the person in the image is standing or sitting, based on the information on the position, size, direction, and ratio of the face object 614 in the object 612 in the image.

In an embodiment, it may be infer that, within the object 612 in the image, there is a ground region 616 opposite the face object 614. The ground region 616 information may be used to determine the intensity of the bokeh effect to be applied by the bokeh effect determination unit 430. For example, in terms of distance, the ground region 616 may be inferred as a region that is closest to the person object 612 included in the image among the background regions. Accordingly, among the background regions, this may be determined by the bokeh effect determination unit 430 as a region to be applied with the least blur effect among the background regions.

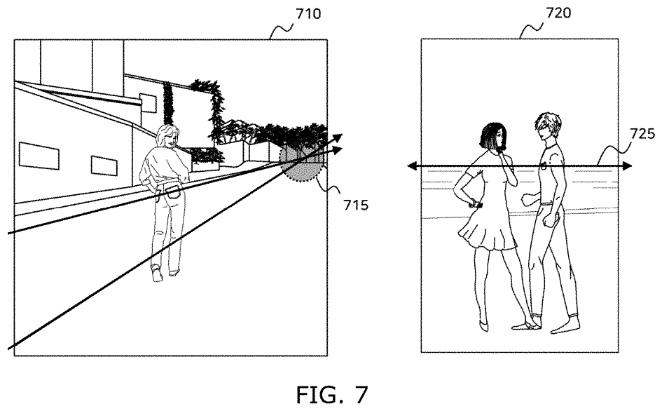

FIG. 7 is an exemplary diagram for explaining a process of analyzing a depth characteristic in an image by detecting at least one of an asymptote (horizon) and a height of a vanishing point included in the image in the process of analyzing the extracted characteristic information of the image according to an embodiment of the present disclosure. As illustrated in FIG. 7, the analyzing the extracted characteristic information of the image may include detecting at least one of an asymptote (horizon) and a height of a vanishing point included in the image, and analyzing a depth characteristic in the image based on at least one of the detected asymptote and height of vanishing point.

In an embodiment, from an image 710 having a background element where a vanishing point is detectable, the characteristic information analysis unit 420 may detect a vanishing point 715 and transmit it to the bokeh effect determination unit 430. The vanishing point 715 may mean a point at which edge components in the image intersect within a certain range. By perspective, an object is projected larger as it gets closer to the viewer's viewpoint and projected smaller as it gets farther from the viewer's viewpoint, and as the object is projected smaller and smaller, lines connecting this will meet as they get farther from the viewer's viewpoint, thus forming the vanishing point 715. That is, except for the sky region, the vanishing point 715 may be inferred as a region at the farthest actual distance from the camera in the image. Accordingly, the vanishing point 715 may be determined by the bokeh effect determination unit 430 as a region to be applied with the greatest blur effect among the background region.

In an embodiment, from an image 720 having a background element where an asymptote (horizon line) is detectable, the characteristic information analysis unit 420 may detect an asymptote (skyline or horizontal line) 725 and transmit it to the bokeh effect determination unit 430. Like the vanishing point, the asymptote 725 may also be inferred as a region at the farthest actual distance from the camera in the image except for the sky region. Accordingly, the asymptote 725 may be determined by the bokeh effect determination unit 430 as a region to be applied with the greatest blur effect among the background region.

Hereinafter, a process by the bokeh effect determination unit 430 for determining the bokeh effect according to the image characteristics according to an embodiment of the present disclosure will be described with reference to FIGS. 8 and 9. As illustrated in FIGS. 8 and 9, the determining the bokeh effect to be applied to the image may include determining, based on the analyzed characteristic information of the image, a type of bokeh effect to be applied to at least a portion of the image and a method of applying the same. The bokeh effect determination unit 430 may be implemented as a simple artificial neural network that performs a classification task. In terms of the intensity of the blur effect of the background region, a region closer to black is illustrated as a stronger blur intensity, and a region closer to white is illustrated as a weaker blur intensity.

FIG. 8 is an exemplary diagram for explaining a process of determining, based on the analyzed characteristic information of the image, a type of bokeh to be applied to an image and a method of applying the same, according to an embodiment of the present disclosure. The bokeh effect determination unit 430 may determine a bokeh effect to be applied to an input image 810. The type of bokeh effect determined by the bokeh effect determination unit 430 may include the flat bokeh, the gradient bokeh, or the like. The bokeh effect determination unit 430 may determine the distribution of blur intensity of the flat bokeh and the blur intensity of the gradient bokeh.

As illustrated in FIG. 8, in an image 820 applied with the flat bokeh, the blur effect of the same intensity may be collectively applied to the background region in the image. In an image 830 applied with the gradient bokeh, different blur intensities may be applied to the background region along a horizontal or vertical axis of the image.

In an embodiment, as illustrated in FIG. 8, with respect to the image 830 applied with the gradient bokeh in the vertical direction, the same horizontal blur intensity may be applied. For the gradient bokeh, an in-focus portion of the background region (or a portion analyzed to be in-focus) may have the least or no blur effect. For the gradient bokeh, a portion at the farthest actual distance (or a portion analyzed to be at the farthest distance) in the background regions may have the strongest blur effect.

In an embodiment, the input image 810 illustrated in FIG. 8 may be an image with the image characteristic determined to be the selfie by the characteristic information analysis unit 420. In the selfie image, a person object may occupy a large portion of the entire image, while the background may occupy a small region. In addition, the difference in the distances of the background regions from the camera may not be large. Accordingly, the bokeh image may look natural too when applied with the flat bokeh that processes blur intensity in batches. Accordingly, the bokeh effect determination unit 430 may determine it appropriate to apply the flat bokeh to an image having image characteristic of a selfie.

In another embodiment, the bokeh effect determination unit 430 may apply the flat bokeh with the faster operation speed and less computational amount than the gradient bokeh to the input image 810, and a segmentation mask corresponding to the person region, which is the region that will not be applied with the blur effect, may be re-calculated, so that the person region that is the aesthetically important portion may have a sharper and more sophisticated edge in the bokeh processing of the selfie image.

FIG. 9 is an exemplary diagram for explaining a process of determining, based on the analyzed characteristic information of the image, a type of bokeh to be applied to an image and a method of applying the same, according to an embodiment of the present disclosure. The bokeh effect determination unit 430 may determine a bokeh effect to be applied to an input image 910.

In an embodiment, the input image 910 illustrated in FIG. 9 may be an image with the image characteristic determined to be the full body shot by the characteristic information analysis unit 420. In the full body shot image, the person object may occupy a small portion of the entire image, while the background may occupy a large region. In addition, the difference in the distances of the background regions from the camera may be large. Accordingly, an image 920 applied with the flat bokeh that collectively processes the blur intensity may look unnatural. As compared to the image 920 applied with the gradient bokeh, an image 930 applied with the flat bokeh may look natural because the blur effect maintains the depth characteristic of the background region. Accordingly, the bokeh effect determination unit 430 may determine it appropriate to apply the gradient bokeh to an image having an image characteristic of a full body shot.

In an embodiment, in the image 930 applied with the gradient bokeh, the region of the vanishing point, the asymptote, and the like analyzed by the characteristic information analysis unit 420 may be a portion at the farthest actual distance or a portion analyzed to be at the farthest distance among the background regions, and accordingly, may be determined to be a region 932 having the strongest blur effect, as illustrated in FIG. 9.

In an embodiment, in the image 930 applied with the gradient bokeh, a ground region analyzed by the characteristic information analysis unit 420 may be a portion at the closest actual distance or a portion analyzed to be at the closest distance among the background regions, and accordingly, may be determined to be a region 934 having the weakest blur effect or no blur effect, as illustrated in FIG. 9.

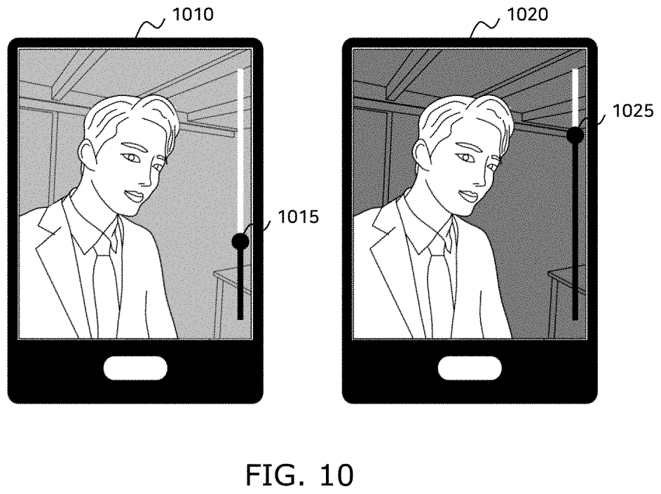

FIG. 10 is an exemplary diagram for explaining a process of receiving input information on intensity of bokeh effect for a bokeh video image according to an embodiment of the present disclosure. As illustrated in FIG. 10, the system for applying a bokeh effect may further include receiving input information on intensity of bokeh effect for a video image. In addition, the applying the bokeh effect to the image may include determining the intensity of the bokeh effect based on the received input information on the intensity, and applying it to the image. In terms of the intensity of the blur effect of the background region, a region closer to black is illustrated as a stronger blur intensity, and a region closer to white is illustrated as a weaker blur intensity.

In an exemplary embodiment, the bokeh effect application unit 440 may determine the intensity of the flat bokeh based on input information 1015 and 1025 on the intensity of the bokeh effect received from the user. For example, when receiving the input information 1015 having a low blur intensity, the bokeh effect application unit 440 may output an image 1010 applied with a weak blur intensity to the background. When receiving the input information 1025 having a high blur intensity, it may output an image 1020 applied with a strong blur intensity to the background.

In another embodiment, the bokeh effect application unit 440 may determine, from the user, the intensity and position of a region having a strong blur effect and the intensity and position of a region having a low blur effect in the gradient bokeh, and apply it to the image.

FIG. 11 is a flowchart for explaining a step of applying a bokeh effect to an image according to an embodiment of the present disclosure. As illustrated in FIG. 11, the applying the determined bokeh effect to the image may include generating sub-images corresponding to regions to be applied with the blur effect in the image, applying the blur effect to sub-images, and mixing the sub-images applied with the blur effect. In addition, the operation may further include down-sampling the image to generate a low resolution image with a lower resolution than that of the image, and the generating the sub-images corresponding to the regions to be applied with the blur effect in the image may include applying the blur effect to regions corresponding to the sub-images in the low resolution image. In addition, the mixing the sub-images applied with the blur effect may include mixing the low resolution image and the sub-images corresponding to the regions applied with the blur effect, up-sampling the low resolution image mixed with the sub-images to a resolution same as the resolution of the image, and mixing the image and the up-sampled images to correct a sharpness of the up-sampled image.

As illustrated in FIG. 11, the bokeh effect application unit 440 may include the sub- image generation module 1110, the sub-image mixing module 1120, the mixed image up- sampling module 1130, and the sharpness correction module 1140.

In an embodiment, in order to ensure a fast operation speed when flat bokeh is applied to the input image, the sub-image generation module 1110 may generate a sub-image obtained by down-sampling the input image to a resolution lower than that of the input image, and a sub-image obtained by applying a blur effect to the down-sampled image, and store the generated sub-images in the storage unit 350. The amount of computation required for the blur effect can be reduced by omitting, that is, by not applying the blur effect to the segmentation mask inner region corresponding to the obj ect region. In addition, in order to improve blur processing speed and quality, a series of image processing steps may be added before and after blur processing.

In an embodiment, in order to ensure a fast operation speed when gradient bokeh is applied to the input image, the sub-image generation module 1110 may generate an image obtained by down-sampling the input image to a resolution lower than that of the input image, and a sub-image obtained by applying a blur effect to the down-sampled image, and may store the generated images in the storage unit 350. For the sub-image, instead of generating an image having a blur intensity that varies according to the pixel position of the gradient bokeh, it is possible to generate images applied with the flat bokeh with a specific blur intensity. For example, when there are first to three levels of blur intensity, for a natural bokeh effect, regions between a region with the first level blur intensity and a region with the second level blur intensity may be generated with the blur intensity with gradation in stages by mixing the image having the first level blur intensity and the image having the second level blur intensity. That is, it may not be necessary to prepare an image having the first level blur intensity for regions having a second or higher level blur intensity. Therefore, it is possible to reduce the amount of computation by calculating only the region having the blur effect greater than K−1 and less than K+1 for the image that is applied with the K-stage blur effect. In addition, the amount of computation required for the blur effect can be reduced by omitting, that is, by not applying the blur effect to the segmentation mask inner region corresponding to the person region. In addition, in order to improve blur processing speed and quality, a series of image processing steps may be added before and after blur processing.

In another embodiment, the sub-image generation module 1110 may use a method of calculating and applying the blur kernel 3×3 twice when calculating the blur kernel 5×5, in order to ensure a fast operation speed during the process of applying the blur effect during the process of generating the sub-image. In addition, in order to ensure a fast operation speed, when calculating the blur kernel 3×3, a method of synthesizing the blur kernel 1×3 and 3×1 may be used.

In an embodiment, the sub-image mixing module 1120 may be omitted when flat bokeh is applied to the input image.

In an embodiment, when applying the gradient bokeh to the input image, the sub-image mixing module 1120 may mix the images applied with the blur effect generated by the sub-image generation module 1110, and store the mixed image in the storage unit 350. For example, for the regions between the region having the first level blur intensity and the region having the second level blur intensity, an image with the first level blur intensity and an image with the second level blur intensity may be linearly mixed.

In another embodiment, in order to implement a natural gradient bokeh effect, the sub-image mixing module 1120 may mix the image with the first level blur intensity and the image with the second level blur intensity at a ratio having a gradual weight which may be expressed as a curve in the form of a quadratic function.

In an embodiment, the mixed image up-sampling module 1130 may up-sample the low resolution image that is mixed by the sub-image mixing module 1120.

In an embodiment, the sharpness correction module 1140 may correct the sharpness of the image applied with bokeh effect by using the original image before being applied with the blur effect. When a kernel (1×1) not applied with the blur effect and a kernel (e.g., 3×3, 5×5, or the like) applied with the blur effect are mixed at a low resolution, when this is up-sampled to a high resolution, the image may appear blurry due to pixel values lost in the process of down-sampling and up-sampling even at positions where no blur effect is applied. When up-sampling the image that was applied with the blur effect at a low resolution back to a high resolution, to increase the sharpness of the image, it is necessary to mix a non-bokeh image of high resolution that is not applied with the blur effect, at a position corresponding to the kernel (1×) (e.g., a person object region inside a segmentation mask) where the blur effect is not applied, so that the sharpness of the input image can be maintained. Accordingly, three images are mixed at this position: the original high resolution input image, the low resolution image not applied with blur effect , and the low resolution image not applied with the blur effect, and when the mixing ratio is set incorrectly, there may be problems with noise or pixel values changing in the image. Accordingly, by using the square root ratio for the original image, the sharpness can be corrected while maintaining the initial ratio of the applied blur effect.

For example, to mix the image applied with the blur effect and the original image are at a ratio of 0.7:0.3, first, an initial mixed image may be generated by mixing the image applied with the blur effect and the low resolution image not applied with the blur effect a ratio of sqrt(0.7):1-sqrt(0.7). Then the initial mixed image may be up-sampled. In addition, mixing of the initial mixed image and the high resolution input image may be performed at a ratio of sqrt(0.7):1-sqrt(0.7). Accordingly, the mixing ratio of the image applied with the blur effect and the low resolution image not applied with the blur effect, and the high resolution input image may be about 0.7:0.14:0.16.

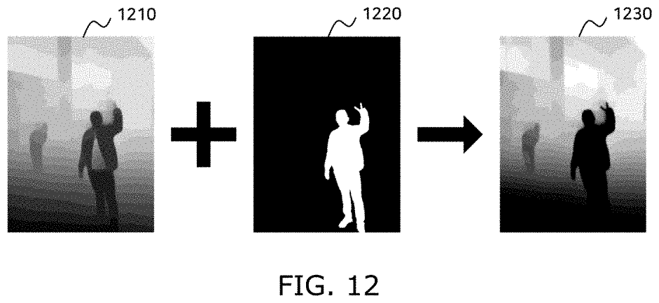

FIG. 12 is an exemplary diagram for explaining a process of correcting a depth map by using a segmentation mask according to an embodiment of the present disclosure. A method for applying a bokeh effect to a video image in a user terminal according to an embodiment of the present disclosure may include (a) receiving information on a plurality of image frames, (b) inputting the information on the plurality of image frames into a first artificial neural network model to generate a segmentation mask 1220 for one or more objects included in the plurality of image frames, (c) inputting the information on the plurality of image frames into a second artificial neural network model to extract a depth map 1210 for the plurality of image frames, and (d) applying a depth effect to the plurality of image frames based on the generated segmentation mask 1220 and the extracted depth map 1210.

In another embodiment, although not limited thereto, the imaging unit 310 may include a depth camera, and may apply a depth effect to a plurality of image frames by using the depth map 1210 obtained through the depth camera. For example, the depth camera may include a time of flight (ToF) sensor and a structured light sensor, but is not limited thereto, and in the present disclosure, even when the depth map 1210 is acquired with a stereo vision method (e.g., of calculating depth values with dual cameras), a processor for calculating a depth value using an additionally provided camera and a plurality of cameras may be referred to as the depth camera.

The system for applying a bokeh effect according to an embodiment of the present disclosure may include an image version of applying the bokeh effect to an image, and a video version of applying the bokeh effect to a video image. In the image version of the system for applying a bokeh effect, which applies the bokeh effect to the image, after the input data (e.g., an image or a plurality of image frames) is input, when the position of the focus is changed through the user input and/or when the intensity of the blur is changed through the user input, the application of the bokeh effect to the input data may be processed in real time. In addition, even when only the ARM CPU is used for the processing for versatility, the application of the bokeh effect to the input data can be processed in real time.

The image version of applying bokeh effect to image may include obtaining in advance filtering images for blur kernels to be used, and filling (e.g., updating) a peripheral region (e.g., difference between a dilate region and an erode region) around the edge of the mask with special filtered values in consideration of the human mask, to prevent the person region and the background region from being blurred by each other. For example, when bokeh effect is applied to the entire image, the boundary between the person region and the background region may appear blurry. Accordingly, it is possible to obtain a high-quality bokeh effect image similar to that captured with an actual DSLR camera, by separating the person region and the background region, then filling the pixels of the background region inside the border of the person region in the space of the separated person region in the background region, then applying the blur effect, and then synthesizing the previously separated person region.

In addition, the image version may include a step of obtaining a result of interpolating each pixel value by using several filtered images (e.g., images filled with special filtered values) prepared in advance, according to the value of the normalized depth map obtained by considering the average depth map and intensity of the in-focus region. When such a bokeh method is applied to an image, changing a focus according to a position inputted by the user and/or changing the intensity of blur according to user input may be performed with the steps of obtaining the normalized depth map and interpolating from the filtered image, without having to perform the filtering process each time. In addition, the special filtered value may refer to any value that can improving the sharpness of image, and may include a value applied with Laplacian kernel which can give a sharpening effect, for example.

In an embodiment, in the system for applying a bokeh effect, when the input data is an image, filtering may be applied first, and then interpolation may be applied according to the normalized depth map. In this case, the filtering images may be generated in advance according to at least one of the sizes and types of various kernels. For example, when the input data is an image, various filters may be applied to one image in advance, and the images applied with filtering may be blended according to a desired effect. For example, when filtering kernel sizes are 1, 3, 7, and 15, a result similar to a result of the filtering kernel size 11 may be output by blending the filtering results of the kernel sizes 7 and 15.

In an embodiment, when the input data is a video image, the system for applying a bokeh effect may perform a method of filtering and interpolating simultaneously according to the normalized depth map. In this case, for example, since the system for applying a bokeh effect may perform filtering for one pixel only once, the size of the filtering kernel may be more densely configured. For example, when kernel sizes 1, 3, 7, and 15 are used in the image version, kernel sizes 1, 3, 5, 7, 9, 11, 13, and 15 may be used in the video version. In other words, for a video, since multiple images need to be output in a short time, it may be advantageous in terms of performance to generate the necessary filters and apply them at once, rather than blending images that are applied with a plurality of filters which is the case of the image version.

In another embodiment, the method of performing the image version and the method of performing the video version may be performed in combination, depending on the performance of hardware forming the system for applying a bokeh effect. For example, a system for applying a bokeh effect configured with low performance hardware may perform a method originally intended for the video version in the image version, and a system for applying a bokeh effect configured with high performance hardware may perform a method originally intended for the image version in the video version, but embodiments are not limited thereto and various other filtering processes may be performed.

In an embodiment, the video version of applying bokeh effect to the video image may change a focus point and a blur intensity whenever a frame color, a depth, and a mask are input, and a throughput may be set to match the frame processing speed of a video device (e.g., 30 frames per second (fps) or 60 fps). For example, a pipeline technique may be applied by using a computing unit to process in accordance with the throughput of 30 fps or 60 fps.

The video version of applying bokeh effect to video image may perform the steps of obtaining a depth value of each pixel value according to a value of a normalized depth map obtained by considering an average depth map and an intensity of the in-focus region, and determining and filtering a kernel to be used for each pixel according to a depth value or the like of each pixel. For example, for a pixel having a depth value of 0.6, it may be 4/7.

In addition, as illustrated in FIG. 12, step (d) may include the steps of correcting the extracted depth map 1210 using the generated segmentation mask 1220, and applying a depth effect to a plurality of image frames based on the corrected depth map 1230.

In an embodiment, as illustrated in FIG. 12, the depth information of the depth map 1210 extracted through the second artificial neural network may be inaccurate. For example, a boundary of a small and detailed part, such as a finger of a person included in the image or plurality of image frames, may be blurred. Alternatively, the depth information may be inaccurately extracted due to a color difference between the top and the coat.

Accordingly, the system for applying a bokeh effect according to an embodiment of the present disclosure may normalize the depth information inside and outside the segmentation mask 1220, respectively, by using the segmentation mask 1220 generated through the first artificial neural network.

In applying the depth effect, when the part to be focused is not included in the segmentation region obtained in the process of detecting and segmenting the object to be focused, a segmentation mask for use in the correction of the depth map may be used.

The method of correcting the depth map may include normalizing a range of a depth map inside the segmentation region to be focused within a predetermined range. In addition, the process of improving the depth map may include homogenizing the depth map inside the unselected segmentation region. For example, the method may include unifying with an average value, making a variance small through Equation 1 below, or applying a median filtering.

representative value×alpha+current value×(1-alpha) [Equation 1]

In addition, the method may include subtracting a representative value (e.g., an average value) of a depth map inside a divided region to be focused from the depth map, obtaining absolute values, and averaging the same.

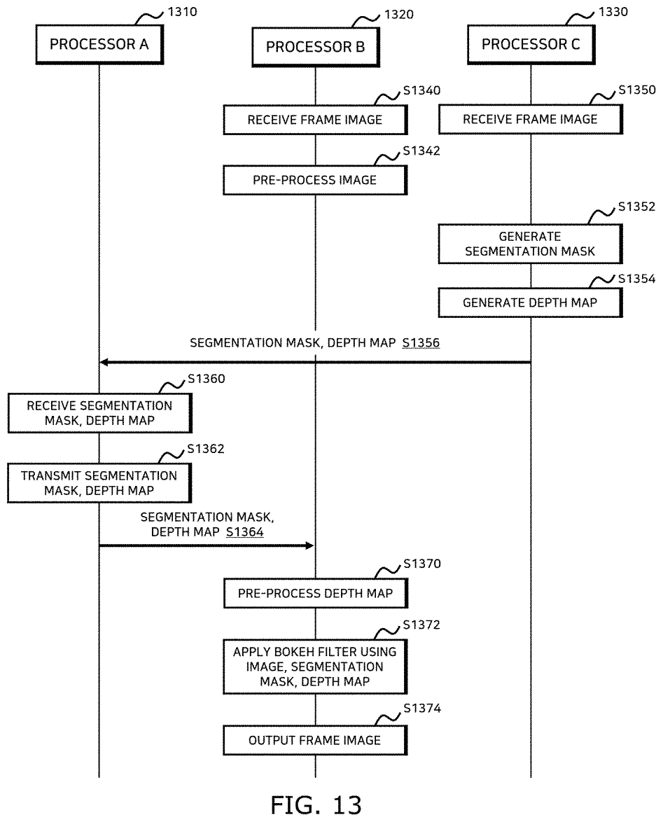

A data flow of a video bokeh solution according to an embodiment of the present disclosure will be described with reference to FIGS. 13 to 16. In an embodiment, each of steps (a) to (d) may be executed by any one of a plurality of heterogeneous processors.

Each of processors A, B, and C illustrated in FIGS. 13 to 16 may be a processor capable of mediating simple pre-processing tasks and data execution, a processor in charge of drawing a screen, and a processor optimized for performing neural network operations (e.g., DSP, NPU, Neural Accelerator, and the like), but is not limited thereto. In addition, as an example, the processor A may be a CPU, the processor B may be a GPU (e.g., a GPU having a GL interface, and the like), and the processor C may be a DSP, but is not limited thereto, and each of processors A to C may include one of the known processors capable of executing a processor configuration.

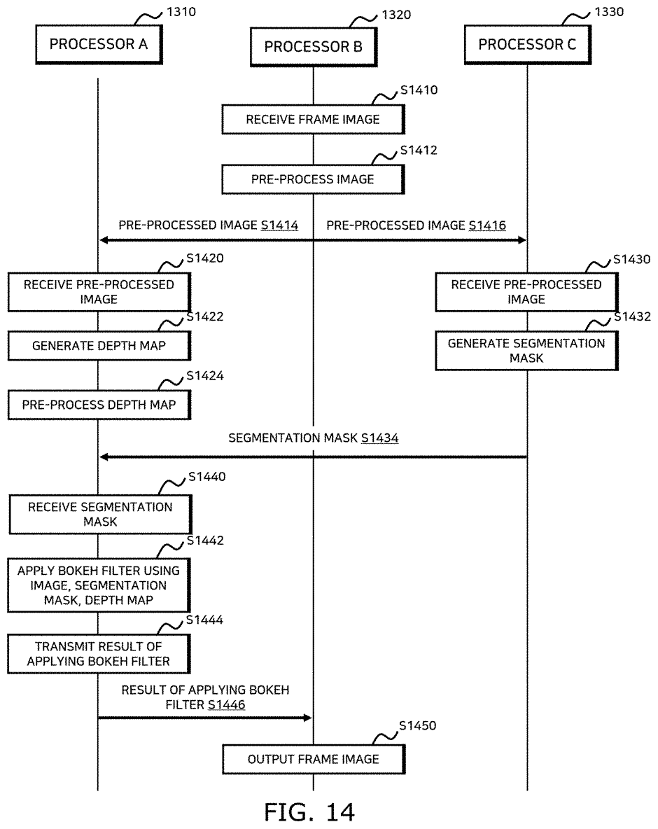

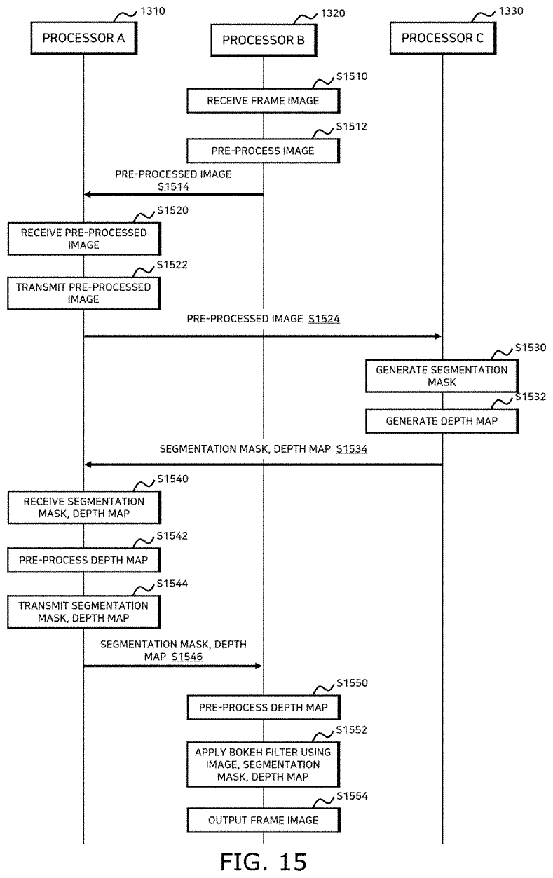

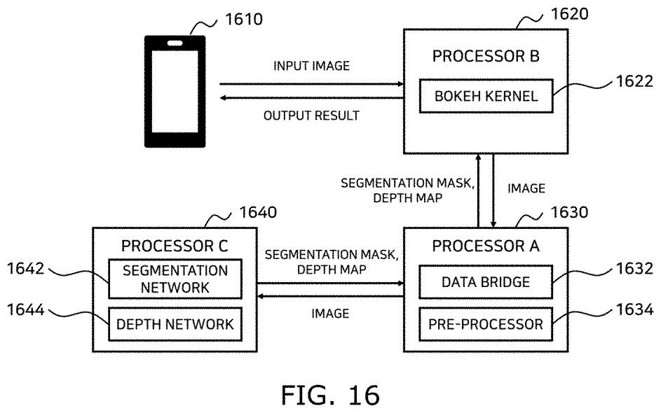

While FIG. 13 illustrates a system in which image data captured by the camera is directly input to the processor C, embodiments are not limited thereto, and it may be input to and processed by one or more processors when the processors are capable of directly receiving the camera input. In addition, although FIG. 14 illustrates that the neural network is performed by two processors (processors A and C), embodiments are not limited thereto, and it may be performed in parallel by several processors. Although each task is illustrated to be processed by each processor in FIG. 15, each task may be divided and processed in stages by a plurality of processors. For example, a plurality of processors may process serially one task as a whole. The flowchart of the data processed in FIG. 16 is just an exemplary embodiment and embodiments are not limited thereto, and various types of data flowcharts may be implemented according to the configuration and function of the processor.

FIG. 13 is a schematic diagram illustrating a data flow of a video bokeh solution according to an embodiment of the present disclosure. As illustrated, processor B 1320 may receive a frame image from the imaging unit 310, at S1340. In an embodiment, the processor B 1320 may pre-process the received frame image, at S1342.

In an embodiment, processor C 1330 may receive a frame image at the same time that the processor B 1320 receives the frame image, at S1350. In an embodiment, the processor C 1330 may include a first artificial neural network model. In an embodiment, the processor C 1330 may generate a segmentation mask corresponding to the frame image received at S1350 using the first artificial neural network model, at S1352. In an embodiment, the processor C 1330 may include a second artificial neural network model. The processor C 1330 may generate a depth map corresponding to the frame image received at S1350 using the second artificial neural network model. The processor C 1330 may transmit the generated segmentation mask and the depth map to the processor A 1310, at S1356.

In an embodiment, the processor A 1310 may receive the segmentation mask and the depth map from the processor C 1330, at S1360. In an embodiment, the processor A 1310 may transmit the received segmentation mask and the depth map to the processor B 1320 (S1362).

In an embodiment, the processor B 1320 may receive the segmentation mask and the depth map from the processor A 1310, at S1364. In an embodiment, the processor B 1320 may pre-process the received depth map, at S1370. In an embodiment, the processor B 1320 may apply the bokeh filter to the image pre-processed by the processor B 1320 at S1342, by using the segmentation mask received from the processor A 1310 and the depth map pre-processed at S1370 by the processor B 1320, at S1372. In an embodiment, the processor B 1320 may output a frame image corresponding to the result of applying the bokeh filter through the output unit 330, at S1374.

FIG. 14 is a schematic diagram illustrating a data flow of a video bokeh solution according to an embodiment of the present disclosure. As illustrated, the processor B 1320 may receive a frame image from the imaging unit 310, at S1410. In an embodiment, the processor B 1320 may pre-process the received frame image, at S1412. The processor B 1320 may transmit the pre-processed image to the processor A 1310, at S1414. In addition, the processor B 1320 may transmit the pre-processed image to the processor C 1330, at S1416.

In an embodiment, the processor A 1310 may receive the pre-processed image from the processor B 1320, at S1420. In an embodiment, the processor A 1310 may include a second artificial neural network model. The processor A 1310 may generate a depth map corresponding to the pre-processed image received at S1420 by using the second artificial neural network model, at S1422. In an embodiment, the processor A 1310 may pre-process the depth map generated at S1422, at S1424.

In an embodiment, the processor C 1330 may receive the pre-processed image from the processor B 1320, at S1430. In an embodiment, the processor C 1330 may include a first artificial neural network model. The processor C 1330 may generate a segmentation mask corresponding to the pre-processed image received at S1430 by using the first artificial neural network model, at S1432. In addition, the processor C 1330 may transmit the generated segmentation mask to the processor A 1310, at S1434.

In an embodiment, the processor A 1310 may receive a segmentation mask from processor C 1330. In an embodiment, the processor A 1310 may apply the bokeh effect filter to the pre-processed image received at S1420 by using the segmentation mask received at S1440 and the depth map pre-processed by the processor A 1310 at S1424, at S1442. In addition, the processor A 1310 may transmit the result of applying the bokeh filter to the processor B 1320, at S1444.

In an embodiment, the processor B 1320 may receive the result of applying the bokeh filter from the processor A 1310, at S1446. In an embodiment, the processor B 1320 may output a frame image corresponding to the result of applying the bokeh filter through the output unit 330, at S1450.

FIG. 15 is a schematic diagram illustrating a data flow of a video bokeh solution according to an embodiment of the present disclosure. As illustrated, the processor B 1320 may receive a frame image from the imaging unit 310, at S1510. In an embodiment, the processor B 1320 may pre-process the received frame image, at S1512. The processor B 1320 may transmit the pre-processed image to the processor A 1310, at S1514.

In an embodiment, the processor A 1310 may receive the pre-processed image from the processor B 1320, at S1520. In an embodiment, the processor A 1310 may transmit the pre-processed image to the processor C 1330, at S1522. In an embodiment, the processor C 1330 may receive the pre-processed image from the processor A 1310, at S1524.

In an embodiment, the processor C 1330 may include a first artificial neural network model. The processor C 1330 may generate a segmentation mask corresponding to the pre-processed image received at S1524 by using the first artificial neural network model. In an embodiment, the processor C 1330 may include a second artificial neural network model.

The processor C 1330 may generate a depth map corresponding to the pre-processed image received at S1524 by using the second artificial neural network model. In addition, the processor C 1330 may transmit the generated segmentation mask and the depth map to the processor A 1310, at S1534.

In an embodiment, the processor A 1310 may receive the segmentation mask and the depth map from the processor C 1330, at S1540. In an embodiment, the processor A 1310 may pre-process the depth map received at S1540, at S1542. In addition, the processor A 1310 may transmit the segmentation mask received at S1540 and the depth map pre-processed at S1542 to the processor B 1320, at S1544.

In an embodiment, the processor B 1320 may receive the segmentation mask and the depth map from the processor A 1310, at S1546. In an embodiment, the processor B 1320 may pre-process the depth map pre-processed by the processor A 1310 again, at S1550.

In an embodiment, the processor B 1320 may apply a bokeh effect filter to the image pre-processed by the processor B 1320 at S1512 by using the segmentation mask and the depth map received at S1544, at S1552. In addition, the processor B 1320 may output a frame image corresponding to the result of applying the bokeh filter through the output unit 330, at S1554.

FIG. 16 is a block diagram of a data flow of a video bokeh solution according to an embodiment of the present disclosure. An input and output interface 1610 illustrated in FIG. 16 may include the imaging unit 310, the input unit 320, and the output unit 330 described above with reference to FIG. 3. For example, the input and output interface 1610 may acquire an image or a plurality of image frames through the imaging unit 310. In addition, the input and output interface 1610 may receive an input for changing the position of the focus and/or the intensity of the bokeh effect from the user through the input unit 320. In addition, the input and output interface 1610 may output a result of applying the bokeh filter generated by the processors A 1630, processor B 1620, and processor C 1640 through the output unit 330.

In an embodiment, the processor B 1620 may include a bokeh kernel 1622. For example, the processor B 1620 may be configured as a GPU in charge of drawing a screen, although embodiments are not limited thereto.

As described above with reference to FIGS. 13 to 16, the bokeh kernel 1622 may apply a bokeh effect filter to an image or a plurality of image frames by using a segmentation mask and a depth map.

In an embodiment, the processor A 1630 may include a data bridge 1632 and a pre-processor 1634. For example, the processor A 1630 may be configured as a CPU capable of mediating simple pre-processing tasks and data execution, but embodiments are not limited thereto.

In an embodiment, the simple pre-processing tasks may include blurring to make the border between the human and the background look smooth, a median filter to remove signal noise such as depth map noise and the like, depth map completion to fill empty spaces in the depth map, and depth map up-sampling that increases the resolution quality of the depth map, and the like, but is not limited thereto, and it may include various pre-processing tasks capable of improving the quality of the output.

In another embodiment, a system for applying a bokeh effect (e.g., the system 300 for applying a bokeh effect) may include a separate artificial neural network model for simple pre-processing tasks such as depth map completion, depth map up-sampling, and the like.

The data bridge 1632 may play a mediating role in performing data between the input and output interface 1610, the processor B 1620, and the processor C 1640. For example, the processor A 1630 may distribute the tasks to be processed by the processor B 1620 and processor C 1640 through calculation, but embodiments are not limited thereto.

The pre-processor 1634 may pre-process the images received from the input and output interface 1610, the processor B 1620 and the processor C 1640, a plurality of image frames, or a depth map.

In an embodiment, the processor C 1640 may include a segmentation network 1642 and a depth network 1644. For example, the processor C 1640 may be configured as a processor optimized for performing a neural network operation, such as a DPS, an NPU, a neural accelerator, and the like, but embodiments are not limited thereto.

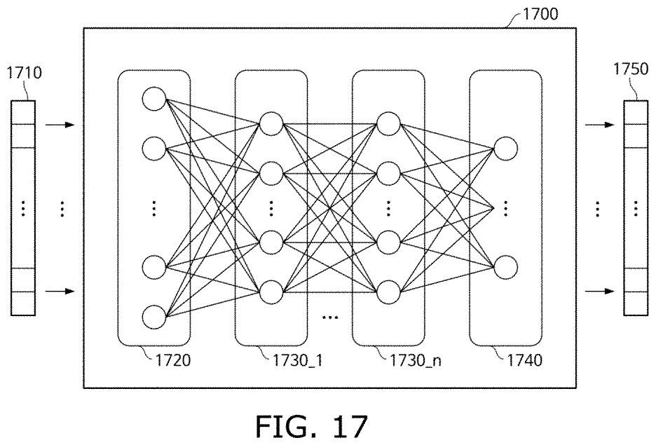

The segmentation network 1642 may receive an image, a plurality of image frames, a pre-processed image, or a plurality of image frames, and generate a segmentation mask. In addition, the segmentation network 1642 may include the first artificial neural network model which will be described below in more detail with reference to FIG. 17.

The depth network 1644 may receive an image, a plurality of image frames, a pre-processed image, or a plurality of image frames, and extract a depth map. In addition, the depth network 1644 may include a second artificial neural network model which will be described below in more detail with reference to FIG. 17.

FIG. 17 illustrates an example of an artificial neural network model according to an embodiment of the present disclosure. In machine learning technology and cognitive science, an artificial neural network model 1700 refers to a statistical training algorithm implemented based on a structure of a biological neural network, or to a structure that executes such algorithm. According to an embodiment, the artificial neural network model 1700 may represent a machine learning model that acquires a problem solving ability by repeatedly adjusting the weights of synapses by the nodes that are artificial neurons forming the network through synaptic combinations as in the biological neural networks, thus training to reduce errors between a target output corresponding to a specific input and a deduced output. For example, the artificial neural network model 1700 may include any probability model, neural network model, and the like, that is used in artificial intelligence learning methods such as machine learning and deep learning.

According to an embodiment, the artificial neural network model 1700 may include a first artificial neural network model configured to input a plurality of image frames including at least one object and/or image features extracted from the plurality of image frames to output a segmentation mask.

According to an embodiment, the artificial neural network model 1700 may include a second artificial neural network model configured to input a plurality of image frames including at least one object and/or image features extracted from the plurality of image frames to output a depth map.

The artificial neural network model 1700 is implemented as a multilayer perceptron (MLP) formed of multiple nodes and connections between them. The artificial neural network model 1700 according to an embodiment may be implemented using one of various artificial neural network model structures including the MLP. As illustrated in FIG. 17, the artificial neural network model 1700 includes an input layer 1720 to receive an input signal or data 1710 from the outside, an output layer 1740 to output an output signal or data 1750 corresponding to the input data, and (n) number of hidden layers 1730_1 to 1730_n (where n is a positive integer) positioned between the input layer 1720 and the output layer 1740 to receive a signal from the input layer 1720, extract the features, and transmit the features to the output layer 1740. In an example, the output layer 1740 receives signals from the hidden layers 1730_1 to 1730_n and outputs them to the outside.

The method of training the artificial neural network model 1700 includes the supervised learning that trains to optimize for solving a problem with inputs of teacher signals (correct answers), and the unsupervised learning that does not require a teacher signal. The processing unit 340 may analyze the plurality of input image frames using supervised learning to output a segmentation mask and/or a depth map from the plurality of training image frames, and train the artificial neural network model 1700 such that a segmentation mask and/or a depth map corresponding to the plurality of image frames may be inferred. The artificial neural network model 1700 trained as described above may be stored in the storage unit 350, and output a segmentation mask and/or a depth map in response to an input of a plurality of image frames including at least one object received by the communication unit 360 and/or the input unit 320.

According to an embodiment, as illustrated in FIG. 17, an input variable of the artificial neural network model 1700 capable of extracting depth information (e.g., depth map) may be a plurality of training image frames including at least one object. For example, the input variable input to the input layer 1720 of the artificial neural network model 1700 may be an image vector 1710 that is the training image configured as one vector data element. In response to an input of the training image including at least one object, an output variable output from the output layer 1740 of the artificial neural network model 1700 may be a vector 1750 that represents a segmentation mask and/or a depth map. In the present disclosure, the output variable of the artificial neural network model 1700 is not limited to the types described above and may include any information or data that indicates a deformable 3D motion model.

As described above, the input layer 1720 and the output layer 1740 of the artificial neural network model 1700 are respectively matched with a plurality of output variables corresponding to a plurality of input variables, and the synaptic values between nodes included in the input layer 1720, the hidden layers 1730_1 to 1730_n, and the output layer 1740 are adjusted, so that by training, a correct output corresponding to a specific input can be extracted. Through this training process, the features hidden in the input variables of the artificial neural network model 1700 can be confirmed, and the synaptic values (or weights) between the nodes of the artificial neural network model 1700 can be adjusted so that there can be a reduced error between the target output and the output variable calculated based on the input variable. In response to a plurality of image frames including at least one input object, information on a segmentation mask and/or a depth map corresponding to a plurality of input image frames may be output by using the artificial neural network model 1700 trained as described above.

The techniques described herein may be implemented by various means. For example, these techniques may be implemented in hardware, firmware, software, or a combination thereof. Those skilled in the art will further appreciate that the various illustrative logical blocks, modules, circuits, and algorithm steps described in connection with the disclosure herein may be implemented in electronic hardware, computer software, or combinations of both. To clearly illustrate this interchangeability of hardware and software, various illustrative components, blocks, modules, circuits, and steps have been described above generally in terms of their functionality. Whether such a function is implemented as hardware or software varies depending on design constraints imposed on the particular application and the overall system. Those skilled in the art may implement the described functions in varying ways for each particular application, but such decisions for implementation should not be interpreted as causing a departure from the scope of the present disclosure.

In a hardware implementation, processing units used to perform the techniques may be implemented in one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described herein, computer, or a combination thereof.

Accordingly, various example logic blocks, modules, and circuits described in connection with the disclosure herein may be implemented or performed with general purpose processors, DSPs, ASICs, FPGAs or other programmable logic devices, discrete gate or transistor logic, discrete hardware components, or any combination of those designed to perform the functions described herein. The general purpose processor may be a microprocessor, but in the alternative, the processor may be any conventional processor, controller, microcontroller, or state machine. The processor may also be implemented as a combination of computing devices, for example, a DSP and microprocessor, a plurality of microprocessors, one or more microprocessors associated with a DSP core, or any other combination of such configurations.

In the implementation using firmware and/or software, the techniques may be implemented with instructions stored on a computer readable medium, such as random access memory (RAM), read-only memory (ROM), non-volatile random access memory (NVRAM), programmable read-only memory (PROM), erasable programmable read-only memory (EPROM), electrically erasable PROM (EPMROM), flash memory, compact disc (CD), magnetic or optical data storage devices, and the like. The instructions may be executable by one or more processors, and may cause the processor(s) to perform certain aspects of the functions described herein.

When implemented in software, the functions may be stored on a computer readable medium as one or more instructions or codes, or may be transmitted through a computer readable medium. The computer-readable media include both the computer storage media and the communication media including any medium that facilitates the transfer of a computer program from one place to another. The storage media may also be any available media that may be accessed by a computer. By way of non-limiting example, such a computer-readable medium may include RAM, ROM, EEPROM, CD-ROM or other optical disk storage, magnetic disk storage or other magnetic storage devices, or any other media that can be used to transfer or store desired program code in the form of instructions or data structures and can be accessed by a computer. In addition, any connection is properly referred to as a computer-readable medium.

For example, when the software is transmitted from a website, server, or other remote sources using coaxial cable, fiber optic cable, twisted pair, digital subscriber line (DSL), or wireless technologies such as infrared, wireless, and microwave, the coaxial cable, the fiber optic cable, the twisted pair, the digital subscriber line, or the wireless technologies such as infrared, wireless, and microwave are included within the definition of the medium. The disks and the discs used herein include CDs, laser disks, optical disks, digital versatile discs (DVDs), floppy disks, and Blu-ray disks, where disks usually magnetically reproduce data, while discs optically reproduce data using a laser. The combinations described above should also be included within the scope of the computer-readable media.

The software module may reside in RAM memory, flash memory, ROM memory, EPROM memory, EEPROM memory, registers, hard disk, removable disk, CD-ROM, or any other form of storage medium known. An exemplary storage medium may be coupled to the processor, such that the processor may read or write information from or to the storage medium. Alternatively, the storage medium may be integrated into the processor. The processor and the storage medium may exist in the ASIC. The ASIC may exist in the user terminal. Alternatively, the processor and storage medium may exist as separate components in the user terminal.

The above description of the present disclosure is provided to enable those skilled in the art to make or use the present disclosure. Various modifications of the present disclosure will be readily apparent to those skilled in the art, and the generic principles defined herein may be applied to various modifications without departing from the spirit or scope of the disclosure. Thus, the present disclosure is not intended to be limited to the examples described herein but is intended to be accorded the broadest scope consistent with the principles and novel features disclosed herein.

Although example implementations may refer to utilizing aspects of the presently disclosed subject matter in the context of one or more standalone computer systems, the subject matter is not so limited, and they may be implemented in conjunction with any computing environment, such as a network or distributed computing environment. Furthermore, aspects of the presently disclosed subject matter may be implemented in or across a plurality of processing chips or devices, and storage may be similarly influenced across a plurality of devices. Such devices may include PCs, network servers, and handheld devices.

Although the present disclosure has been described in connection with some embodiments herein, it should be understood that various modifications and changes can be made without departing from the scope of the present disclosure, which can be understood by those skilled in the art to which the present disclosure pertains. In addition, such modifications and changes should be considered within the scope of the claims appended herein.

What is claimed is:

1. A method for applying a bokeh effect to a video image in a user terminal, comprising:
extracting characteristic information of an image from the image included in the video image;
analyzing the extracted characteristic information of the image;
determining a bokeh effect to be applied to the image based on the analyzed characteristic information of the image; and
applying the determined bokeh effect to the image.

2. The method according to claim 1, wherein the analyzing the extracted characteristic information of the image includes:
detecting an object in the image;
generating a region corresponding to the object in the image;
determining at least one of a position, a size, and a direction of the region corresponding to the object in the image; and
analyzing characteristics of the image based on information on at least one of a position, a size, and a direction of the region corresponding to the object.

3. The method according to claim 2, wherein the object in the image may include at least one of a person object, a face object, and a landmark object included in the image,
the determining at least one of the position, size, and direction of the object in the image includes determining a ratio between a size of the image and a size of the region corresponding to the object, and
the analyzing the characteristics of the image based on the information on at least one of the position, size, and direction of the object includes classifying a pose of the object included in the image.

4. The method according to claim 1, wherein the analyzing the extracted characteristic information of the image includes:
detecting at least one of an asymptote and a height of a vanishing point included in the image; and
analyzing a depth characteristic in the image based on at least one of the detected asymptote and height of vanishing point.

5. The method according to claim 1, wherein the determining the bokeh effect to be applied to the image includes, based on the analyzed characteristic information of the image, determining a type of a bokeh effect to be applied to at least a portion of the image and a method of applying the same.

6. The method according to claim 1, further comprising receiving input information on an intensity of the bokeh effect for the video image, wherein the applying the bokeh effect to the image includes determining an intensity of the bokeh effect based on the received input information on the intensity, and applying the bokeh effect to the image according to the determination.

7. The method according to claim 1, wherein the applying the determined bokeh effect to the image includes:
generating sub-images corresponding to regions to which a blur effect is to be applied in the image;
applying the blur effect to the sub-images; and
mixing the sub-images applied with the blur effect.

8. The method according to claim 7, further comprising down-sampling the image to generate a low resolution image with a lower resolution than that of the image, wherein the generating the sub-images corresponding to the regions applied with the blur effect in the image includes applying a blur effect to the regions corresponding to the sub-images in the low resolution image.

9. The method according to claim 8, wherein the mixing the sub-images applied with the blur effect includes:
mixing the low resolution image and the sub-images corresponding to the regions applied with the blur effect;
up-sampling the low resolution image mixed with the sub-images to a resolution same as the resolution of the image; and mixing the image and the up-sampled images to correct a sharpness of the up- sampled image.

10. A method for applying a bokeh effect to a video image in a user terminal, comprising the steps of:
a) receiving information on a plurality of image frames;
b) inputting the information on the plurality of image frames into a first artificial neural network model to generate a segmentation mask for one or more obj ects included in the plurality of image frames;
c) inputting the information on the plurality of image frames into a second artificial neural network model to extract a depth map for the plurality of image frames; and
d) applying a depth effect to the plurality of image frames based on the generated segmentation mask and extracted depth map.

11. The method according to claim 10, wherein the step (d) includes:
correcting the extracted depth map using the generated segmentation mask; and
applying a depth effect to the plurality of image frames based on the corrected depth map.

12. The method according to claim 10, wherein each of the steps (a) to (d) is executed by any one of a plurality of heterogeneous processors.

13. A non-transitory computer-readable recording medium storing a computer program for executing, on a computer, the method for applying a bokeh effect to a video image in a user terminal as set forth in claim 1.
